(19) United States
(12) Patent Application Publication
(10) Pub. No.: US 2014/0013195 A1
(43) Pub. Date: Jan. 9, 2014

(54) CONTENT REFERENCE IN EXTENSIBLE MARKUP LANGUAGE DOCUMENTS

(71) Applicant: Steffen Richard FREDERIKSEN, Skanderborg (DK)

(72) Inventor: Steffen Richard FREDERIKSEN, Skanderborg (DK)

(73) Assignee: DITA EXCHANGE, INC., Campbell, CA (US)

(21) Appl. No.: 13/543,107

(22) Filed: Jul. 6, 2012

(51) Int. Cl. G06F 17/00

(52) U.S. Cl. 715/205; 715/234

(57) ABSTRACT

A method includes creating a content reference to content within a first document, where the content reference includes an action parameter that indicates that the content referenced by the content reference is automatically fetched and inserted at a time that the content reference is resolved. The method further includes inserting the content reference within a second document. The method further includes dynamically resolving the content reference. The method further includes automatically fetching the content referenced by the content reference from the first document. The method further includes automatically inserting the content within the second document.

### BACKGROUND

1. Field

Certain embodiments of the invention relate generally to computer systems, and, more particularly, to computer systems that are configured to manage documents.

2. Description of the Related Art

In general, if an author of an electronic document (i.e., document) would like to reuse a content fragment (such as a paragraph, a table, a list, or a group of paragraphs) from another document in the current document, there is no commercially feasible mechanism to provide this functionality. While an author can hyperlink to content in another document, such as a Microsoft Word® document, generally the author cannot render the hyperlinked content in situ in the current document. As a special case of this problem, there is generally no mechanism to allow an author to insert a series of variables in a document to be resolved at the time the document is published, where each of the variables can reference content from another document.

For example, if a document author (such as a pharmaceutical company) may have a large collection of documents (such as a collection of documents associated with a request for approval of a drug from the Food and Drug Administration), where the collection of documents includes documents A, B, C, and D. In document D, the author can create content (such as a table) that the author desires to reuse in document A. In order to reuse the content, the author is required to open document D, navigate to the content, execute a cut-and-paste (or copy-and-paste) operation, and paste the content in document A. However, the author would be required to manually perform this operation every time the content in document D is modified (for example, to fix errors), in order to incorporate the modified content in document A.

### SUMMARY

According to an embodiment of the invention, a method includes creating a content reference to content within a first document, where the content reference includes an action parameter that indicates that the content referenced by the content reference is automatically fetched and inserted at a time that the content reference is resolved. The method further includes inserting the content reference within a second document. The method further includes dynamically resolving the content reference. The method further includes automatically fetching the content referenced by the content reference from the first document. The method further includes automatically inserting the content within the second document.

According to another embodiment, an apparatus includes a memory configured to store one or more modules. The apparatus further includes a processor configured to execute one or more modules stored within the memory. The apparatus further includes a content reference creation module configured to create a content reference to content within a first document, where the content reference includes an action parameter that indicates that the content referenced by the content reference is automatically fetched and inserted at a time that the content reference is resolved. The apparatus further includes a content reference insertion module configured to insert the content reference within a second document. The apparatus further includes a content reference resolution module configured to dynamically resolve the content reference. The apparatus further includes a content fetching module configured to automatically fetch the content referenced by the content reference from the first document. The apparatus further includes a content insertion module configured to automatically insert the content within the second document.

According to another embodiment, a non-transitory computer-readable medium, including a computer program embodied therein, is configured to control a processor to implement a method. The method includes creating a content reference to content within a first document, where the content reference includes an action parameter that indicates that the content referenced by the content reference is automatically fetched and inserted at a time that the content reference is resolved. The method further includes inserting the content reference within a second document. The method further includes dynamically resolving the content reference. The method further includes automatically fetching the content referenced by the content reference from the first document. The method further includes automatically inserting the content within the second document.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a block diagram of an apparatus, according to an embodiment of the invention.

FIG. 2 illustrates a process of creating a content reference that references content within a referenced document, and inserting the content reference in a referencing document, according to an embodiment of the invention.

FIG. 3 illustrates a process of opening a document that includes a content reference within a word processor, according to an embodiment of the invention.

FIG. 4 illustrates a process of publishing and rendering a document that includes a content reference, according to an embodiment of the invention.

FIG. 5 illustrates a method, according to an embodiment of the invention.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “an embodiment,” “one embodiment,” “another embodiment,” “an alternative embodiment,” “an alternate embodiment,” “certain embodiments,” “some embodiments,” “different embodiments” or other similar language, throughout this specification refers to the fact that a particular feature, structure, or characteristic described in connection with the embodiment may be included in at least one embodiment of the present invention. Thus, appearances of the phrases “an embodiment,” “one embodiment,” “another embodiment,” “an alternative embodiment,” “an alternate embodiment,” “in certain embodiments,” “in some embodiments,” “in other embodiments,” “in different embodiments,” or other similar language, throughout this specification do not necessarily all refer to the same group of embodiments, and the described features, structures, or characteristics may be combined in any suitable manner in one or more embodiments.

According to one embodiment, a user can reuse content (such as a paragraph, a table, a list, or a group of paragraphs) from one document in another document. The user can reuse content by inserting a reference (such as a hyperlink) within a first document (i.e., a reference document), where the reference references a second document (i.e., a source document). The insertion of a reference can be part of a content reference protocol (such as a hyperlink protocol). When the reference document is either published or rendered, the reference contained within the reference document can be dynamically resolved, where content that is referenced by the reference is identified, and the reference document can be updated to include the referenced content.

In the following description, the following terms are used as synonyms: Office Open XML document, Open XML document, and/or Microsoft Word® document. All refer to the Microsoft Word® 2007/2010 default document format (*.docx), as further described and defined by the Office Open XML specification standardized by Ecma (i.e., ECMA-376), and subsequently described and defined by International Organization for Standardization (ISO) and International Electrotechnical Commission (IEC) (i.e., ISO/IEC standard 29500).

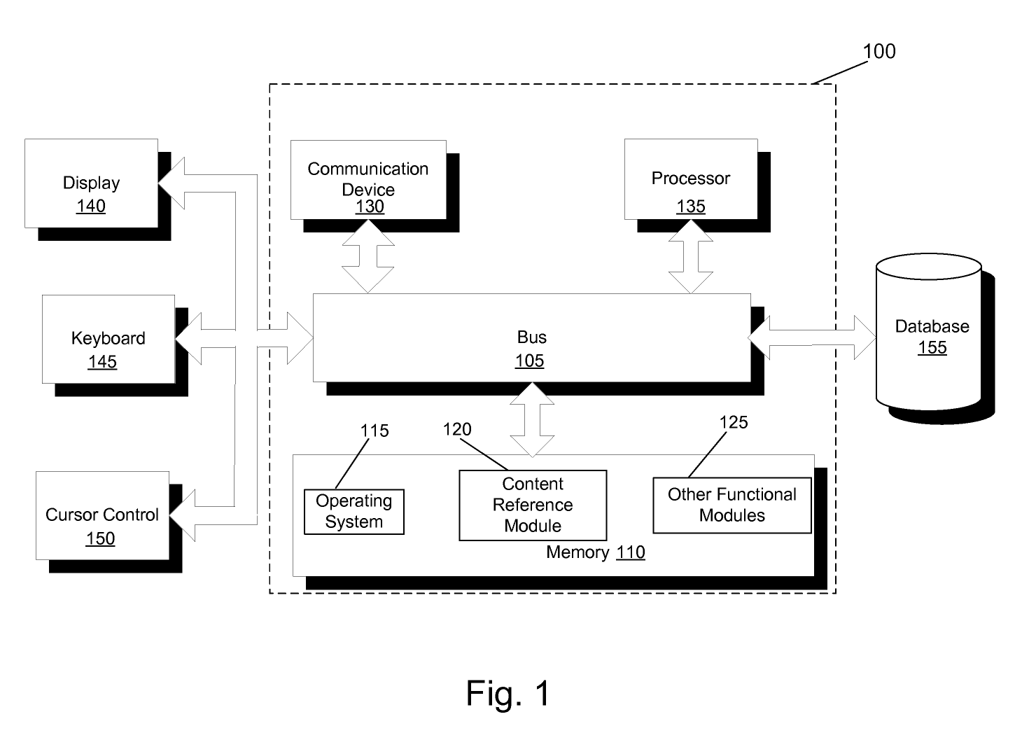

FIG. 1 illustrates a block diagram of an apparatus 100, according to an embodiment of the invention. Apparatus 100 includes a bus 105 or other communications mechanism for communicating information between components of apparatus 100. Apparatus 100 also includes a processor 135, operatively coupled to bus 105, for processing information and executing instructions or operations. Processor 135 may be any type of general or specific purpose processor. Apparatus 100 further includes a memory 110 for storing information and instructions to be executed by processor 135. Memory 110 can be comprised of any combination of random access memory (RAM), read only memory (ROM), static storage such as a magnetic or optical disk, or any other type of machine or computer-readable medium. Apparatus 100 further includes a communication device 130, such as a network interface card or other communications interface, to provide access to a network. As a result, a user may interface with apparatus 100 directly, or remotely through a network or any other method. In addition, apparatus 100 may interface with any resources through a network using communication device 130.

A computer-readable medium may be any available medium that can be accessed by processor 135. A computer-readable medium may include both a volatile and nonvolatile medium, a removable and non-removable medium, and a storage medium. A storage medium may include RAM, flash memory, ROM, erasable programmable read-only memory (EPROM), electrically erasable programmable read-only memory (EEPROM), registers, hard disk, a removable disk, a compact disc read-only memory (CD-ROM), or any other form of storage medium known in the art.

Processor 135 can also be operatively coupled via bus 105 to a display 140, such as a Liquid Crystal Display (LCD). Display 140 can display information to the user. A keyboard 145 and a cursor control device 150, such as a computer mouse, can also be operatively coupled to bus 105 to enable the user to interface with apparatus 100.

According to one embodiment, memory 110 can store software modules (i.e., modules) that may provide functionality when executed by processor 135. The modules can include an operating system 115, a content reference module 120, as well as other functional modules 125. Operating system 115 can provide an operating system functionality for apparatus 100. Content reference module 120 can provide functionality for dynamically referencing and reusing content, as is described in more detail below. In certain embodiments, content reference module 120 can comprise a plurality of modules that each provide specific individual functionality for dynamically referencing and reusing content. Apparatus 100 can also be part of a larger system. Thus, apparatus 100 can include one or more additional functional modules 125 to include the additional functionality. In certain embodiments, additional functional modules 125 can include a word processor module that can provide functionality for word processing, such as opening, editing, and saving one or more documents. In some of these embodiments, the word processor module can be a Microsoft Word® module.

Processor 135 can also be operatively coupled via bus 105 to a database 155. Database 155 can store data in an integrated collection of logically-related records or files. Database 155 can be an operational database, an analytical database, a data warehouse, a distributed database, an end-user database, an external database, a navigational database, an in-memory database, a document-oriented database, a real-time database, a relational database, an object-oriented database, or any other database known in the art.

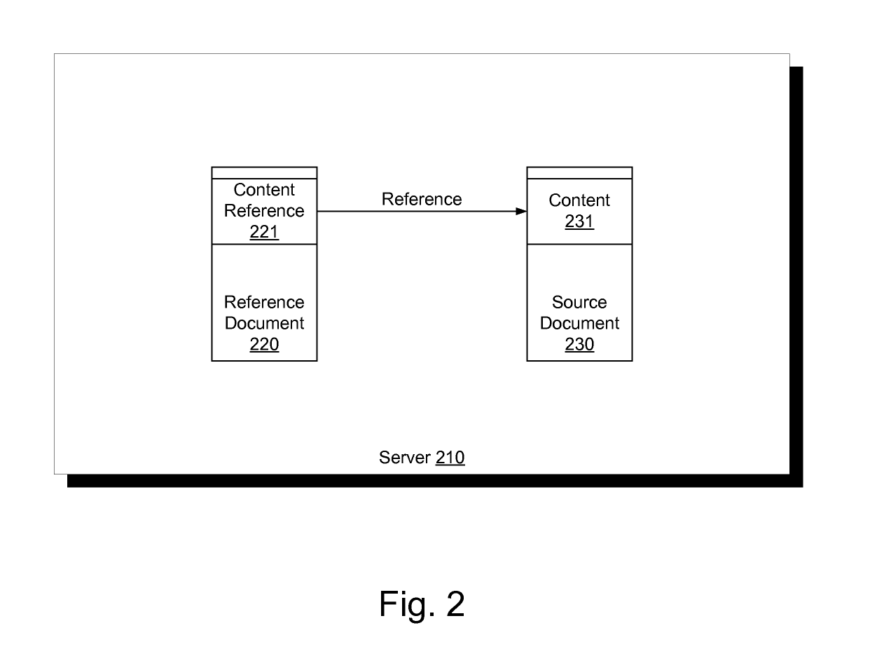

FIG. 2 illustrates a process of creating a content reference that references content within a referenced document, and inserting the content reference in a referencing document, according to an embodiment of the invention. In certain embodiments, the process can be implemented by content reference module 120 of FIG. 1, when executed by processor 135 of FIG. 1. According to the embodiment, the process involves a server 210. Server 210 can be any type of server that is known to one of ordinary skill in the relevant art, such as an application server, or a web server. In certain embodiments, server 210 is a content management server. A content management server is a server that provides functionality for publishing, editing, and modifying content, such as one or more documents. Such functionality can include: allowing multiple users to share and contribute to stored content; controlling access to content based on a role associated with a user; facilitating storage and retrieval of content; controlling content validity and compliance; reducing duplicate inputs of content; defining what type of content can be stored within the content management server (e.g., what type of documents can be stored), and producing one or more reports based on content stored. In certain embodiments, server 210 is a Microsoft SharePoint® server.

In certain embodiments, reference document 220 and source document 230 are stored within server 210. Reference document 220 and source document 230 are each capable of storing content. In certain embodiments, reference document 220 and source document 230 are XML documents (such as Open Office XML documents). In alternate embodiments, additional documents (not shown in FIG. 2) can be stored within server 210.

According to the embodiment, as illustrated in FIG. 2, content reference 221 can be created and inserted within reference document 220. Content reference 221 is a reference to content 231 contained within source document 230, where content 231 can include any type of content, such as text, a paragraph, a collection of paragraphs, a table, or a chart. In certain embodiments where reference document 220 and source document 230 are Open Office XML documents, content reference 221 is an Open XML Word document hyperlink that is part of an Office Open XML hyperlinking protocol. In these embodiments, the Open XML Word document hyperlink references a bookmark within source document 230, where the bookmark contains content 231. As one of ordinary skill in the art would readily appreciate, a bookmark is a location of a selection of content that can be identified for future reference.

In certain embodiments, content reference 221 includes an action parameter, where an action parameter indicates that the content referenced by content reference (i.e., content 231) is to be automatically fetched and inserted at runtime (i.e., at a time that content reference 221 is resolved). In the embodiments where content reference 221 is a hyperlink, the action parameter can indicate that the content referenced by the hyperlink (i.e., content 231) is to be automatically fetched and inserted at a time the hyperlink is resolved. Examples of a content reference (e.g., content reference 221) that include an action parameter include: http://www.intranet.com/sourcedocument.docx#mybookmark?dxaction=conref http://www.intranet.com/sourcedocument.docx#mybookmark?dxaction=stringref

In the above content reference examples, the portion “http://www.intranet.com/sourcedocument.docx” represents a source document. Also in the above content reference examples, the portion “mybookmark” represents the bookmark contained within the source document that contains the content of the source document that is referenced by the content reference. Also in the above content reference examples, the portions “dxaction=conref” and “dxaction=stringref” represent action parameters. The action parameter “dxaction=conref” indicates that the referenced content is to be automatically fetched and inserted as XML content at a time that the content reference is resolved. The action parameter “dxaction=stringref” indicates that the referenced content is to be automatically fetched and inserted as text content at a time that the content reference is resolved.

In certain embodiments, content reference 221 also includes a literal string token, where a literal string token indicates that the source document is specified at runtime (i.e., at a time that content reference 221 is resolved). More specifically, in the illustrated embodiment, the source document (e.g., source document 230) that contains the referenced content (e.g., content 231) is identified within the content reference (e.g., content reference 221). However, in alternate embodiments, the source document is not identified within the content reference, but instead is identified at runtime (i.e., when the content reference is resolved). As will be discussed in more detail, this can be when the reference document is opened within a word processor, such as Microsoft Word®, stored, downloaded, published, or rendered. In the alternate embodiments, the identification of the source document at runtime (i.e., when the content reference is resolved) is accomplished using the literal token string. The literal token string acts as a placeholder for the location of the source document. At runtime (i.e., when the content reference is resolved), the literal token string is replaced with the location of the source document. Examples of a content reference (e.g., content reference 221) that include an literal token string include:

dx-var-file#mybookmark?dxaction=conref
dx-current-map#mybookmark?dxaction=conref

In the above content reference examples, the portions “dx-var-file” and “dx-current-map” represent literal token strings. The literal token string “dx-var-file” indicates a uniform resource locator (URL), where the URL indicates a location of a source document that contains the referenced content. The literal token string “dx-current-map” indicates a map, where the map indicates a location of a source document that contains the referenced content.

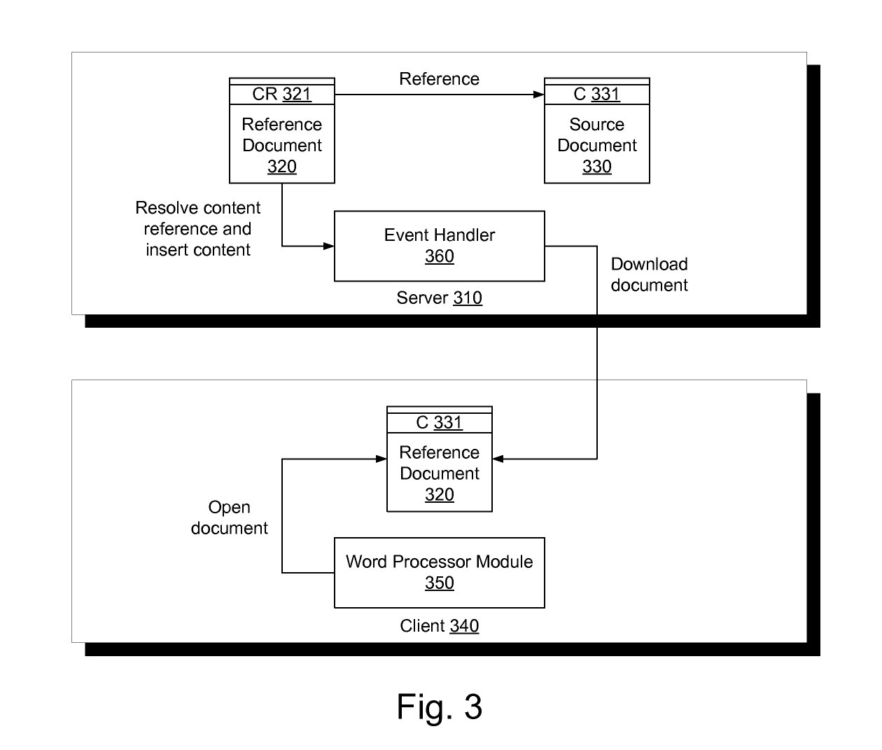

FIG. 3 illustrates a process of opening a document that includes a content reference within a word processor, according to an embodiment of the invention. In certain embodiments, the process can be implemented by content reference module 120 of FIG. 1, when executed by processor 135 of FIG. 1. According to the embodiment, the process involves a server 310 and a client 340. Similar to server 210 of FIG. 2, server 310 can be any type of server that is known to one of ordinary skill in the relevant art, such as an application server, or a web server. In certain embodiments, server 310 is a content management server. Further, client 340 can be any computer system or software application that can access content stored on server 310, such as a personal computer, a laptop computer, a tablet computer, a personal digital assistant (PDA), or a mobile device.

In certain embodiments, reference document 320 and source document 330 are stored within server 310. Similar to reference document 220 and source document 230 of FIG. 2, reference document 320 and source document 330 are each capable of storing content. In certain embodiments, reference document 320 and source document 330 are XML documents (such as Open Office XML documents). In alternate embodiments, additional documents (not shown in FIG. 3) can be stored within server 310.

According to the embodiment, client 340 includes word processor module 350. Word processor module 350 can provide functionality for word processing, such as opening, editing, and saving one or more documents. In some embodiments, word processor module 350 can be a Microsoft Word® module.

According to the embodiment, as previously described in relation to FIG. 2, and illustrated in FIG. 3, content reference 321 (identified as CR 321 in FIG. 3) can be created and inserted within reference document 320. Content reference 321 is a reference to content 331 (identified as C 331 in FIG. 3) contained within source document 330, where content 331 can include any type of content, such as text, a paragraph, a collection of paragraphs, a table, or a chart. In certain embodiments where reference document 320 and source document 330 are Open Office XML documents, content reference 321 is an Open XML Word document hyperlink that is part of an Office Open XML hyperlinking protocol. In these embodiments, the Open XML Word document hyperlink references a bookmark within source document 330, where the bookmark contains content 331.

According to the embodiment, reference document 320 can be opened by word processor module 350. As part of the opening process, reference document 320 can be downloaded or stored onto client 340. In alternate embodiments, reference document 320 can be downloaded or stored onto client 340 without being opened by word processor module. According to the embodiment, as part of the process, an event handler 360 can call a processor, such as processor 135 of FIG. 1, (not shown in FIG. 3) where the processor can dynamically resolve content reference 321, automatically fetch content 331 from source document 330, and insert content 331 within reference document 320. Thus, as illustrated in FIG. 3, reference document 320 can be stored or downloaded onto client 340, where reference document 320 includes content 331. In certain embodiments, content 331 can automatically be fetched from source document 330, regardless of whether content 331 has been updated. Also, in certain embodiments, the dynamic resolution of content reference 321, the automatic fetching of content 331, and the insertion of content 331 are all performed by the processor, where the processor is located at server 310. According to the embodiment, reference document 320 can be opened within word processor module 350, where the word processor module 350 can display content of reference document 320, including content 331.

According to certain embodiments where content reference 321 is a hyperlink, and content reference 321 includes an action parameter “dxaction=conref,” the processor can open the target Open XML document referenced by the hyperlink (i.e., source document 330), select the bookmarked content (i.e., content 311), and copy the content as XML (such as an InnerXml) of the bookmarked Open XML content to the Open XML document containing the hyperlink (i.e., reference document 320). In other embodiments where content reference 321 is a hyperlink, and content reference 321 include an action parameter “dxaction=stringref,” the processor can open the target Open XML document referenced by the hyperlink (i.e., source document 330), select the bookmarked content (i.e., content 311), and copy the content as text (such as an InnerText) of the bookmarked Open XML content to the Open XML document containing the hyperlink (i.e., reference document 320).

According to certain embodiments where content reference 321 is a hyperlink, and content reference 321 includes a literal token string “dx-var-file,” the processor can accept, as input, an Open XML document URL, and insert the URL in place of the literal token string. The processor can then process the resolved URL as described in the previous paragraph based on the action parameter of content reference 321. In other embodiments, where content reference 321 is a hyperlink, and content reference 321 includes a literal token string “dx-current-map,” the processor can accept, as input, a map, and insert the map in place of the literal token string. The processor can then process the resolved map as described in the previous paragraph based on the action parameter of content reference 321. In the context of this application, the term “map” refers to a special type of XML document that only contains metadata and a tree-structure, where each node in the tree structure is a reference to another document. A map can also be referred to as a “map file.” A map or map file can be used to define a publication as a compilation of a sub-document (as defined by the tree-structure).

Below is an example of a map file:

```
<?xml version=“1.0” encoding=“utf-8”?>
<map id=“Map63ea740b-73fd-45cb-b13f-8b5a374d9fb3”
title=“AM-HTS-G-Aa-AL-208” product=“”>
  <data name=“ProductVersion” value=“1.234.5678”/>
  <data name=“BusinessUnit” value=“Dev.APAC”/>
  <data name=“BusinessProcess” value=“RD”/>
  <data name=“Market” value=“B2B”/>
  <data name=“Region” value=“APAC”/>
  <topicref navtitle=“Omschrijving werk”
href=“http://www.dct.com/repository/c3fbbcf8-fe72-49ad-9394-
35b4cb9bab69.dita”>
  <topicref navtitle=“Werkzaamheden”
href=“http://www.dct.com/repository/ef382c17-34f8-4501-9340-
5905962b9da6.dita”>
    <topicref navtitle=“Gestelde eisen”
href=“http://www.dct.com/repository/cbcfa45d-fc1c-4faa-81c3-
19b4e0c42515.dita”/>
  </topicref>
  </topicref>
  <topicref navtitle=“Veiligheidseisen variant 1”
href=“http://www.dct.com/repository/cb75596b-3af3-4c41-b179-
b81f7f25af28.dita”/>
</map>
```

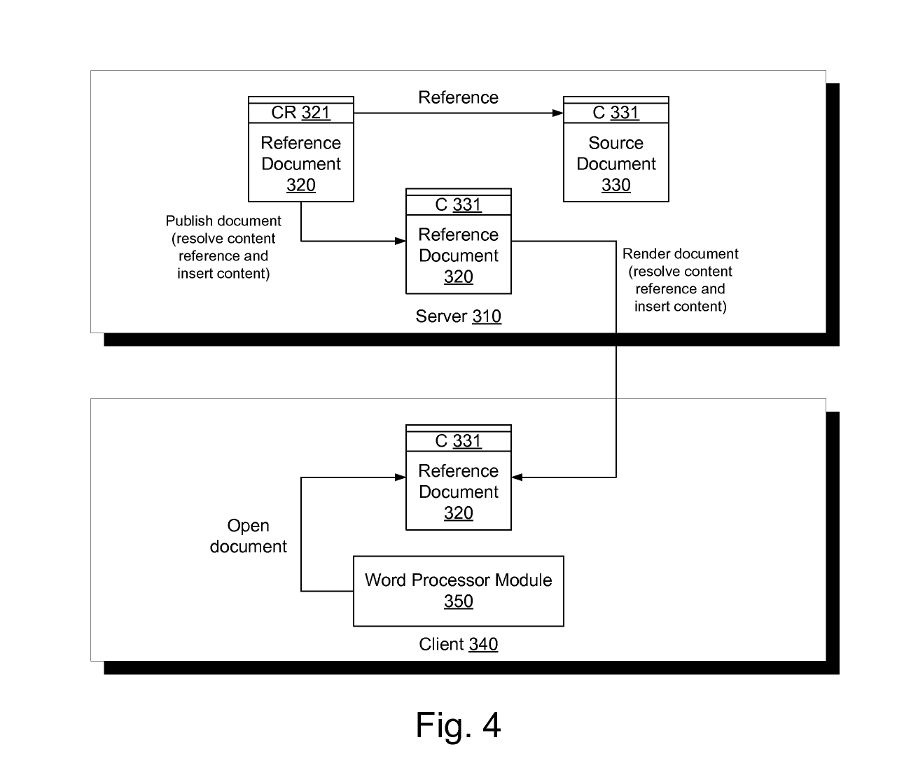

FIG. 4 illustrates a process of publishing and rendering a document that includes a content reference, according to an embodiment of the invention. In certain embodiments, the process can be implemented by content reference module 120 of FIG. 1, when executed by processor 135 of FIG. 1. According to the embodiment, the process involves server 310 and client 340. Server 310 and client 340 are previously described in relation to FIG. 3, and that description is not repeated for sake of brevity. In addition, reference document 320 and source document 330 are stored within server 310. Reference document 320 and source document 330 are also previously described in relation to FIG. 3, and that description is also not repeated for sake of brevity. Finally, according to the process, content reference 321 (identified as CR 321 in FIG. 4) can be created and inserted within reference document 320, where content reference 321 is a reference to content 331 (identified as C 331 in FIG. 4) contained within source document 330. Content reference 321 and content 331 are also previously described in relation to FIG. 3, and that description is also not repeated for sake of brevity.

According to the embodiment, reference document 320 can be published by server 310. As one of ordinary skill in the art would readily appreciate, by publishing a document, the document can be saved in a location, where the document is available for reading and editing by one or more users. As part of the publishing process, a processor, such as processor 135 of FIG. 1, (not shown in FIG. 3) can be called, where the processor can dynamically resolve content reference 321, automatically fetch content 331 from source document 330, and insert content 331 within reference document 320. According to the embodiment, reference document 320 can also be rendered by server 310, so that reference document 320 can be opened by client 340, using, for example, word processor module 350. As one of ordinary skill in the art would also readily appreciate, by rendering a document, the content of the document can be displayed within an editor, such as a word processor editor. In certain embodiments where the publishing process does not dynamically resolve content reference 321, as part of the rendering process, a processor, such as processor 135 of FIG. 1, (not shown in FIG. 3) can be called, where the processor can dynamically resolve content reference 321, automatically fetch content 331 from source document 330, and insert content 331 within reference document 320.

Thus, as illustrated in FIG. 4, reference document 320 can be stored or downloaded onto client 340, where reference document 320 includes content 331. According to the embodiment, reference document 320 can be opened within word processor module 350, where the word processor module 350 can display content of reference document 320, including content 331.

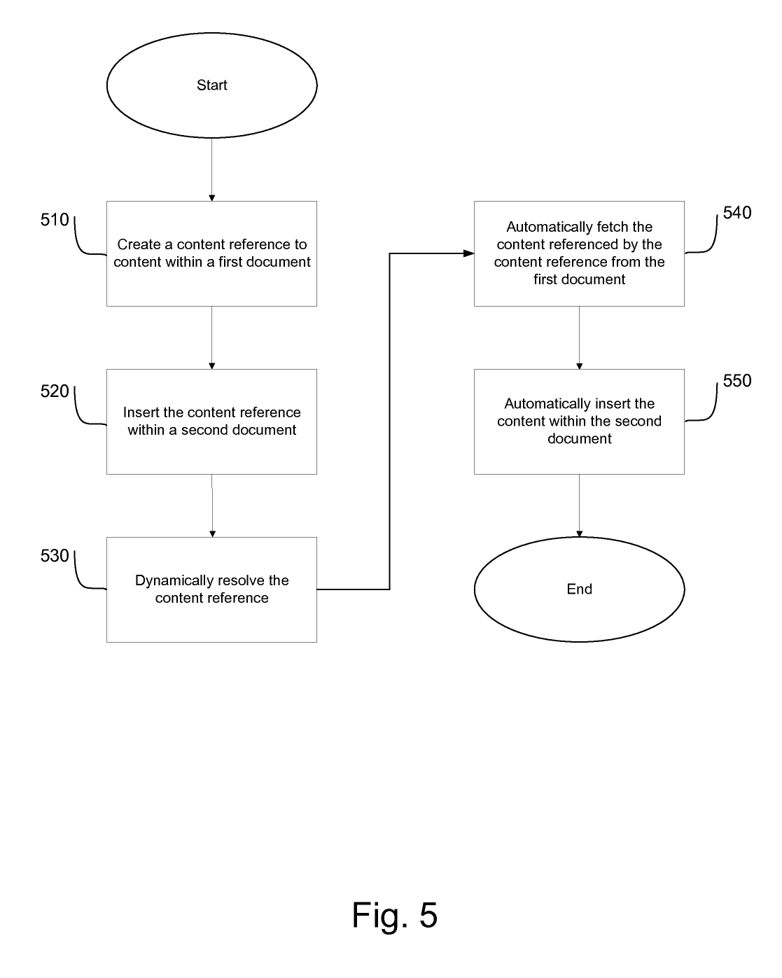

FIG. 5 illustrates a method according to an embodiment of the invention. The steps of a method or algorithm described in connection with the embodiments disclosed herein may be embodied directly in hardware, in a computer program executed by a processor, or in a combination of the two. A computer program may be embodied on a computer-readable medium, such as a storage medium. For example, a computer program may reside in RAM, flash memory, ROM, EPROM, EEPROM, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components. Furthermore, a computer-readable medium may be any type of tangible medium.

The flow begins and proceeds to step 510. At step 510, a content reference to content within a first document is created. The content reference can include an action parameter that indicates that the content reference by the content reference is automatically fetched and inserted at a time that the content reference is resolved. The content reference can also include a literal token string that indicates that the first document is specified at a time that the content reference is resolved. In certain embodiments, the content reference is a hyperlink, and the first document is an Open Office XML document. Also in certain embodiments, the content within the first document can include, at least one of, a paragraph, a table, a list, or a group of paragraphs. The flow then proceeds to step 520.

At step 520, the content reference is inserted into a second document. In certain embodiments, the second document is an Open Office XML document. The flow then proceeds to step 530.

At step 530, the content reference is dynamically resolved. The dynamic resolution of the content reference can include the identification of the content referenced by the content reference within the second document. In certain embodiments, the dynamic resolution of the content reference can be performed while opening the second document within a word processor. In some of those embodiments, the word processor is a Microsoft Office Word® word processor. In other embodiments, the dynamic resolution of the content reference can be performed while publishing the document. In yet other embodiments, the dynamic resolution of the content reference can be performed while rendering the document. In certain embodiments, the dynamic resolution of the content reference can be performed at a content management server. In some of those embodiments, the content management server is a Microsoft Sharepoint® server. The flow then proceeds to step 540.

At step 540, the content referenced by the content reference is automatically fetched from the first document. In certain embodiments, the automatic fetching of the content can be performed while opening the second document within a word processor. In some of those embodiments, the word processor is a Microsoft Office Word® word processor. In other embodiments, the automatic fetching of the content can be performed while publishing the document. In yet other embodiments, the automatic fetching of the content can be performed while rendering the document. In certain embodiments, the automatic fetching of the content can be performed at a content management server. In some of those embodiments, the content management server is a Microsoft Sharepoint® server. The flow then proceeds to step 550.

At step 550, the content is automatically inserted within the second document. In certain embodiments, the insertion of the content can be performed while opening the second document within a word processor. In some of those embodiments, the word processor is a Microsoft Office Word® word processor. In other embodiments, the insertion of the content can be performed while publishing the document. In yet other embodiments, the insertion of the content can be performed while rendering the document. In certain embodiments, the insertion of the content can be performed at a content management server. In some of those embodiments, the content management server is a Microsoft Sharepoint® server. The flow then ends.

Thus, according to certain embodiments, in-place reuse of content from one document to another document can be provided in a flexible, easily managed way, involving a processor that works as previously described. When one or more literal string tokens are used, this content reuse can be made even more dynamic by relying on a separate input of a document at rendering time.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
creating a content reference to content within a first Office Open extensible markup language (XML) document, wherein the content reference comprises an action parameter that indicates that the content referenced by the content reference is automatically fetched and inserted at a time that the content reference is resolved;
inserting the content reference within a second Office Open XML document;
dynamically resolving the content reference;
automatically fetching the content referenced by the content reference from the first Office Open XML document; and
automatically inserting the content within the second Office Open XML document.

2. The method of claim 1, wherein the dynamic resolution of the content reference, the automatic fetching of the content, and the insertion of the content are performed while opening the second Office Open XML document within a word processor.

3. The method of claim 2, wherein the word processor comprises a Microsoft Office Word® word processor.

4. The method of claim 1, wherein the dynamic resolution of the content reference, the automatic fetching of the content, and the insertion of the content are all performed while rendering the second Office Open XML document.

5. The method of claim 1, wherein the content reference comprises a literal token string that indicates that the first Office Open XML document is specified at a time that the content reference is resolved.

6. The method of claim 1, wherein the dynamic resolution of the content reference, the automatic fetching of the content, and the insertion of the content are all performed at a content management server.

7. The method of claim 7, wherein the content manager server comprises a Microsoft Sharepoint® server.

8. The method of claim 1, wherein the content reference comprises a hyperlink.

9. An apparatus, comprising:
a memory configured to store one or more modules;
a processor configured to execute one or more modules stored within the memory;
a content reference creation module configured to create a content reference to content within a first Office Open extensible markup language (XML) document, wherein the content reference comprises an action parameter that indicates that the content referenced by the content reference is automatically fetched and inserted at a time that the content reference is resolved;
a content reference insertion module configured to insert the content reference within a second Office Open XML document;
a content reference resolution module configured to dynamically resolve the content reference;
a content fetching module configured to automatically fetch the content referenced by the content reference from the first Office Open XML document; and
a content insertion module configured to automatically insert the content within the second Office Open XML document.

10. The apparatus of claim 9, wherein the dynamic resolution of the content reference, the automatic fetching of the content, and the insertion of the content are performed while the apparatus opens the second Office Open XML document within a word processor.

11. The apparatus of claim 10, wherein the word processor comprises a Microsoft Office Word® word processor.

12. The apparatus of claim 9, wherein the dynamic resolution of the content reference, the automatic fetching of the content, and the insertion of the content are all performed while the apparatus renders the second Office Open XML document.

13. The apparatus of claim 9, wherein the content reference comprises a literal token string that indicates that the first Office Open XML document is specified at a time that the content reference is resolved.

14. The apparatus of claim 9, wherein the apparatus comprises a content management server.

15. The apparatus of claim 14, wherein the content manager server comprises a Microsoft Sharepoint® server.

16. The apparatus of claim 9, wherein the content reference comprises a hyperlink.

17. A non-transitory computer-readable medium, comprising a computer program embodied therein, configured to control a processor to implement a method, the method comprising:
creating a content reference to content within a first Office Open extensible markup language (XML) document, wherein the content reference comprises an action parameter that indicates that the content referenced by the content reference is automatically fetched and inserted at a time that the content reference is resolved;
inserting the content reference within a second Office Open XML document;
dynamically resolving the content reference;
automatically fetching the content referenced by the content reference from the first Office Open XML document; and
automatically inserting the content within the second Office Open XML document.

18. The non-transitory computer-readable medium of claim 17, wherein the dynamic resolution of the content reference, the automatic fetching of the content, and the insertion of the content are performed while opening the second Office Open XML document within a word processor.

19. The non-transitory computer-readable medium of claim 17, wherein the content reference comprises a literal token string that indicates that the first Office Open XML document is specified at a time that the content reference is resolved.

20. The non-transitory computer-readable medium of claim 17, wherein the content reference comprises a hyperlink.
